(19) United States
(12) Patent Application Publication
(10) Pub. No.: US 2003/0231506 A1
(43) Pub. Date: Dec. 18, 2003

(54) Exhaust pipe with flickering light

(76) Inventor: Hui-Ling Chen, Yung-Kang City (TW)

Correspondence Address: Hui-Ling Chen, P.O. Box 90, Tainan City, 704, TW

(21) Appl. No.: 10/172,021

(22) Filed: Jun. 17, 2002

(51) Int. Cl. B60Q 1/00

(52) U.S. Cl. 362/487; 138/110; 362/253; 362/540; 362/546

(57) ABSTRACT

An exhaust pipe with flickering light includes an annular position plate and a protective sleeve fixed on a position pipe. The position plate is provided to stabilize a tubular outer cover and prevent an annular electric board from damaged when the outer cover is knocked. The protective sleeve is provided for preventing heat and from getting too high and protecting the electric board from damaged so as to increase its service life.

### BACKGROUND OF THE INVENTION

1. Field of the Invention

This invention relates to an exhaust pipe with flickering light, particularly to one having a position plate and a protective sleeve fixed on a position pipe, with the position plate stabilizing an outer cover to prevent an electric board from damaged in case of the outer cover being knocked, and with the protective sleeve preventing heat and protecting the electric board from damaged so as to prolong its service life.

2. Description of the Prior Art

A conventional exhaust pipe with flickering light, as shown in FIG. 1, includes an exhaust pipe 10 having a position pipe 12 fixedly fitted around the rear portion by means of combining members 11. The position pipe 12 is provided with a fixing base 13, and an electric board 15 is firmly positioned on a rear portion of the fixing base 13 by bolts 14. The electric board 15 is bored with a through hole 150 in the center, and provided with a plurality of light emitting diodes 151 (LED) and an electric wire 152. Then, an outer cover 16 is fitted around the rear portion of the fixing base 13, having numerous light-transmitting holes 160 in the tubular wall and a through hole 161 at the bottom wall for the electric wire 152 of the electric board 15 to pass therethrough and connected with a power to produce flickering light around the exhaust pipe.

However, the electric board 15 employed in the conventional exhaust pipe is simply fitted around the position pipe 12 directly and secured on the fixing base 13 by bolts 14 so it can hardly be stabilized in position. Under such a condition, in case a car runs on an uneven road, the electric board 15 and the outer cover 16 is liable to sway about, and should the exhaust pipe 10 be bumped, the outer cover will easily become inclined to one side and the electric board 15 located in the outer cover 16 will be damaged, because there is nothing provided between the outer cover 16 and the position pipe 12 to stabilize them in place. Besides, the electric board 15 being directly fitted on the position pipe 12 is likely to be influenced by the high temperature of the gas exhausted from the exhaust pipe 10, thus possible to be shortened in its service life.

### SUMMARY OF THE INVENTION

The objective of the invention is to offer an exhaust pipe with flickering light, possible to be stably assembled and able to prevent heat from getting too high and protect an electric board from damaged so as to prolong its service life.

The feature of the invention is that a plurality of long rods and short rods protruding forward and interposed with one another are provided at the rear side of an annular fixing base, and an annular position plate is mounted on a position pipe to support the inner wall of a tubular outer cover, having a through hole in the center, and plural large and small through holes arranged interposed with one another on the wall. Further, a protective sleeve is fitted around the position pipe and provided at the front end with an annular fixing plate having a plurality of large and small through holes corresponding to the through holes of the fixing plate, with plural bolts respectively inserted through the small holes of the position plate and the protective sleeve and screwed with the short rods of the fixing base. An annular electric board is positioned around the protective sleeve and secured with the long rods of the fixing base, and provided with plural small through holes and light emitting diodes (LED) as well as an electric wire, with plural bolts respectively inserted through the small through holes of the electric board and fixedly screwed with the long rods of the fixing base.

### BRIEF DESCRIPTION OF DRAWINGS

This invention will be better understood by referring to the accompanying drawings, wherein:

FIG. 1 is a cross-sectional view of a conventional exhaust pipe;

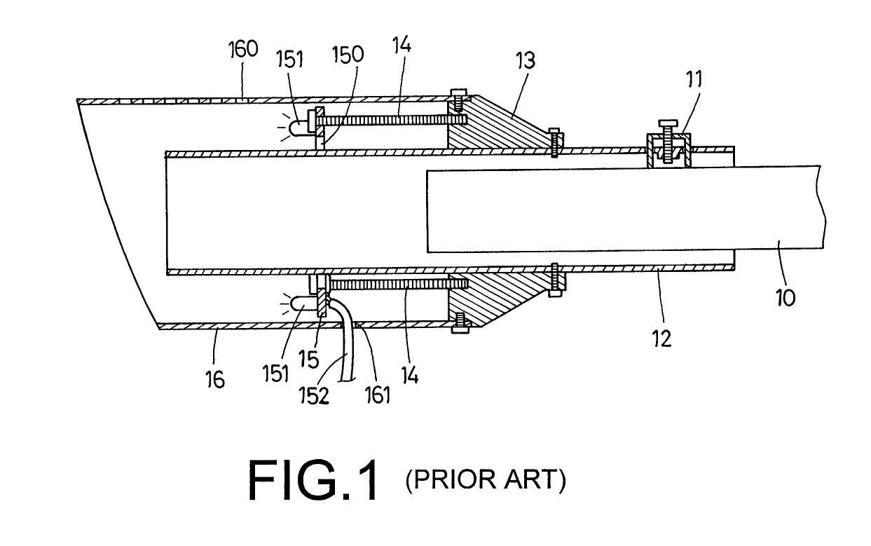

FIG. 2 is an exploded perspective view of an exhaust pipe with flickering light in the present invention; and,

FIG. 3 is a cross-sectional view of the exhaust pipe with flickering light in the present invention.

### DETAILED DESCRIPTION OF THE PREFERRED EMBODIMENT

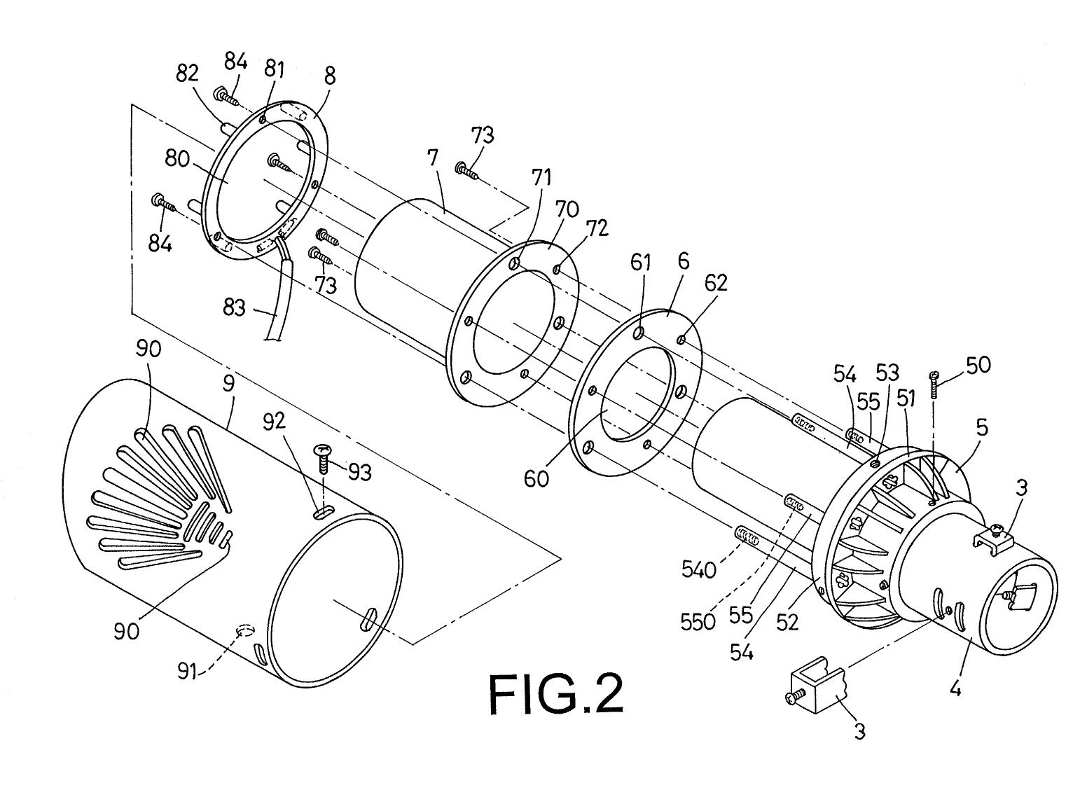

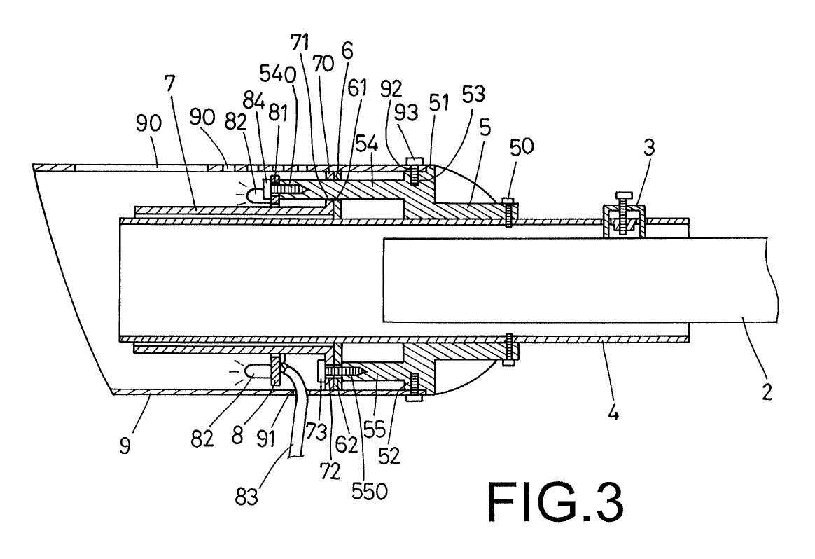

A preferred embodiment of an exhaust pipe with flickering light in the present invention, as shown in FIGS. 2 and 3, includes an exhaust pipe 2, a position pipe 4, a fixing base 5, a position plate 6, a protective sleeve 7, an electric board 8 and an outer cover 9 as main components combined together.

The position pipe 4 is assembled around the rear portion of the exhaust pipe 2 by means of combining members 3, with the fixing base 5 mounted around the position pipe 4.

The fixing base 5 is annular, combined with the position pipe 4 by bolts 50 and provided with a blocking edge 51 having an annular projection 52 with threaded holes 53 at the rear portion. The fixing base 5 is further provided on the rear side with three long rods 54 and three short rods 55 formed spaced apart equidistantly and arranged interposed with one another, with each long rod 54 and short rod 55 extending out horizontally and bored with a threaded hole 540, 550 at the outer end.

The position plate 6 is annular, fitted around the position pipe 4, and formed with a through hole 60 in the center and three large and three small through holes 61 and 62 spaced apart equidistantly and interposed with one another in its wall.

The protective sleeve 7 is mounted around an position pipe 4 and provided on the front end with a annular fixing plate 70 having three large and three small through holes 71 and 72 matching with the through holes 61, 62 of the position plate 6, with three bolts 73 respectively inserted through the small through holes 72.

The electric board 8 is shaped annular, disposed around the protective sleeve 7 and secured with the long rods 54 of the fixing base 5. The electric board 8 is bored with a through hole 80 in the center and three small through holes 81 spaced apart equidistantly in the annular wall, and provided with several light emitting diodes 82(LED) and an electric wire 83, with three bolts 84 inserted through the small through holes 81.

The outer cover 9 is tubular, mounted around the electric board 8, the protective sleeve 7 and the position plate 6, and fixedly assembled with the projection 52 of the fixing base 5. The outer cover 9 is provided with a plurality of light-transmitting holes 90 in the tubular wall, a through hole 91 at the bottom wall for the electric wire 83 of the electric board 8 to be inserted there through and plural slots 92 spaced apart near a front edge for receiving bolts 93.

In assembling and using, as shown in FIGS. 2 and 3, the fixing base 5 is first combined with the position pipe 4 by means of bolts 50. Then, the position plate 6 is fitted around the position pipe 4, letting the long rods 54 of the fixing base 5 respectively inserted through the large through holes 61 of the position plate 6, with the inner side of the position plate 6 resting on the short rods 55 of the fixing base 5, and the threaded holes 550 of the short rods 55 respectively aligned to the small through holes 62 of the position plate 6. Afterward, the protective sleeve 7 is fitted around the position pipe 4, letting the long rods 54 of the fixing base 5 inserted through the large through holes 71 of the protective sleeve 7, and the fixing plate 70 of the protective sleeve 7 closely contacting with the position plate 6, with the small through holes 72 of the protective sleeve 7 exactly facing the small through holes 62 of the position plate 6. Then, the three bolts 73 are respectively inserted orderly through the small through holes 72 and 62 of the protective sleeve 7 and the position plate 6 and then firmly screwed with the threaded holes 550 of the short rods 55 of the fixing base 5 to make the position plate 6 and the protective sleeve 7 fixed on the position pipe 4.

Next, the electric board 8 is fitted around the protective sleeve 7, having its inner wall resting on the long rods 54 of the fixing base 5 and its small through holes 8 respectively aligned and screwed with the threaded holes 540 of the fixing base 5 by means of bolts 84 so as to stabilize the electric board 8 on the protective sleeve 7. Subsequently, the outer cover 9 is orderly mounted around the electric board 8, the protective sleeve 7, the position plate 6 and the projection 52 at the rear side of the fixing base 5 and fixed in position by bolts 93, which are respectively inserted through the slots 93 of the outer cover 9 and screwed together with the threaded holes 53 of the projections 52, thus the outer cover 9 having its inner wall supported by the position plate 6 to increase its strength and avoid swaying caused by vibration. Lastly, the position pipe 4 is combined with the exhaust pipe 2 by means of combining members 3 to finish the assembling of an exhaust pipe. Then the electric wire 83 is connected to the power source of a car to enable the light emitting diodes 82 to produce flickering light, which can emit outward through the light transmitting holes 90 of the outer cover 9 to make up a variety of flashes.

To sum up, the light transmitting holes 90 are provided not only for transmitting flickering light, but also for ventilating and heat dispersing. The outer cover 9 having its inner wall supported by the position plate 6 is able to prevent the electric board 8 from damaged by direct collision in case of the outer cover 9 being knocked, and the protective sleeve 7 located between the electric board 8 and the position pipe 4 can prevent heat from getting too high and protect the electric board 8 from damaged so as to increase its service life.

While the preferred embodiment of the invention has been described above, it will be recognized and understood that various modifications may be made therein and the appended claims are intended to cover all such modifications that may fall within the spirit and scope of the invention.

What is claimed is:

1. An exhaust pipe with flickering light comprising an exhaust pipe assembled with a position pipe at a rear portion by means of combining members, said position pipe mounted around with an annular fixing base by means of bolts, said fixing base formed with a blocking edge, said blocking edge having its rear side formed with an annular projection having a plurality of threaded holes in its wall, a tubular outer cover fitted around a rear portion of said fixing base and secured on said annular projection of said fixing base, said outer cover bored with a plurality of light transmitting holes spaced apart in its wall and a through hole at the bottom of the wall; and,
characterized by a plurality of long rods and short rods provided at the rear side of said fixing base, said long rods and said short rods protruding outward horizontally from said fixing base and interposed with one another and respectively having a threaded hole; at least one annular position plate positioned on said position pipe to support an inner wall of said outer cover, said position plate bored with a through hole in the center and plural large and small through holes arranged interposed with one another in the wall; a protective sleeve mounted around said position pipe, said protective sleeve provided with an annular fixing plate at a front side, said fixing plate formed with plural large and small through holes matching with said through holes of said position plate, plural bolts respectively inserted through said small through holes of said position plate and said protective sleeve and respectively screwed with said short rods of said fixing base; an annular electric board fitted around said protective sleeve and secured with said long rods of said fixing base, said electric board bored with several small through holes and provided with numerous light emitting diodes (LED) as well as an electric wire, with plural bolts inserted through said small through holes of said electric board and screwed firmly with said long rods of said fixing base, said position plate fixed with said position pipe to stabilize said outer cover and prevent said electric board from damaged in the event of said outer cover being knocked, said protective sleeve fixed with said position pipe for preventing heat and protecting said electric board to prolong its service life.
